(19) United States
(12) Patent Application Publication
(10) Pub. No.: US 2019/0379171 A1
(43) Pub. Date: Dec. 12, 2019

(54) USB - COAXIAL CABLE CONNECTOR

(71) Applicant: James Henderson, Eufaula, AL (US)

(72) Inventor: James Henderson, Eufaula, AL (US)

(21) Appl. No.: 16/003,414

(22) Filed: Jun. 8, 2018

(51) Int. Cl. H01R 31/06

(52) U.S. Cl. CPC H01R 31/06

(57) ABSTRACT

A USB-Coaxial Cable connector that includes: a first end, where the first end includes USB connector; and a second end, where the second end includes a coaxial cable connector. In one embodiment, the USB-Coaxial Cable connector includes a female USB connector at the first end and a male coaxial connector at the second end. In a second embodiment, the USB-Coaxial Cable connector includes a male USB connector and the second end includes a female coaxial connector.

### BACKGROUND OF THE INVENTION

### Field of Invention

The present invention relates to a USB coaxial cable connector that includes male and female connection options.

### Description of Related Art

USB connectors are common connectors used to connect to principally computer systems in the form of desktops, laptops or tablets. USB connectors are also used on other electronic devices for transfer of data and images. The USB connector is usually associated with a cord that connects two electronic devices or an electronic device to a memory storage data device. Images may be transmitted in the form of pictures or video through USB connectors. Similarly, coaxial cables may utilized for the transmission of video imaging and audio transmission. Coaxial connectors are used on various electronic devices and may to need to interface with a USB connection. It would be advantageous to have a connector that may convert or provide a USB and a coaxial connector for the transfer directly into or out of an electronic device that may include a USB connection. Transversely, a USB/coaxial connector may be necessary for a USB connection into a coaxial feed.

### SUMMARY OF THE INVENTION

The present invention relates to a USB-Coaxial Cable connector that includes: a first end, where the first end includes USB connector; and a second end, where the second end includes a coaxial cable connector. In one embodiment, the USB-Coaxial Cable connector includes a female USB connector at the first end and a male coaxial connector at the second end. In a second embodiment, the USB-Coaxial Cable connector includes a male USB connector and the second end includes a female coaxial connector.

### BRIEF DESCRIPTION OF DRAWINGS

FIG. 1 depicts a first embodiment of a USB coaxial connector in accordance with the present invention.

FIG. 2 depicts a second embodiment of a USB coaxial connection.

### DETAILED DESCRIPTION

The present invention relates to a USB coaxial cable connector that includes a first end and a second end. The first end includes a USB connector and the second end includes a coaxial cable connector. The present invention is contemplated via two embodiments, where a USB female connector is coupled with a male coaxial cable connector. The second embodiment relates to a male USB connector coupled with a female coaxial cable connector.

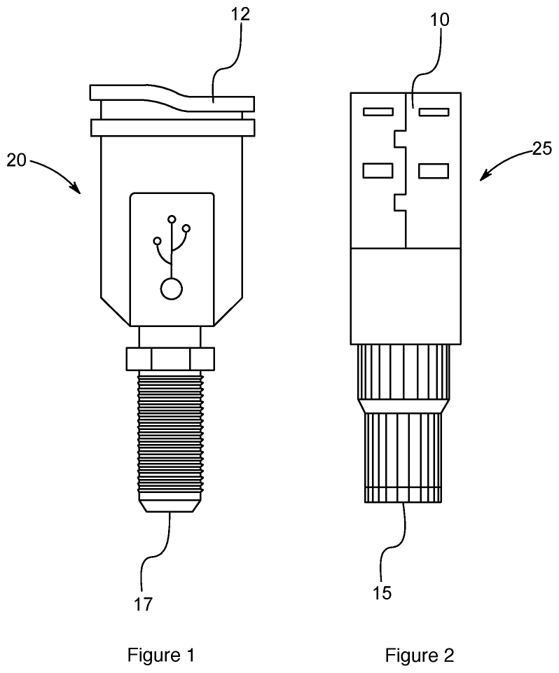

In reference to FIG. 1, a USB coaxial connector 20 is depicted. This USB coaxial connector 20 includes a female USB end 12 and a male coaxial cable end 17. This connector 20 enables the insertion of a USB male connector into the female USB end 12. The opposing end is enabled for adjoining to a coaxial cable with the coaxial male end 17. In a converse embodiment shown in FIG. 2, a USB coaxial connector 25 is depicted. This USB coaxial connector 25 includes a USB male end 10 and female end 15. This connection also enables the insertion of the USB male end 10 into an electronic device for the receiving of a coaxial cable into the female end 15. The present invention provides a unique connector to transfer imaging, data and/or audio via a USB and coaxial cables in a single connection.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A USB-Coaxial Cable connector comprising:
a. a first end, where the first end includes a selective USB connector; and
b. a second end, where the second end includes a selective coaxial cable connector.

2. The USB-Coaxial Cable connector according to claim 1, where the USB connector is a female connector.

3. The USB-Coaxial Cable connector according to claim 1, where the USB connector is a male connector.

4. The USB-Coaxial Cable connector according to claim 1, where the second end includes a male coaxial connector.

5. The USB-Coaxial Cable connector according to claim 1, where the second end includes a female coaxial connector.
